(19) United States
(12) Patent Application Publication
(10) Pub. No.: US 2024/0020738 A1
(43) Pub. Date: Jan. 18, 2024

(54) SYSTEMS AND METHODS FOR OPERATING A PARKING FACILITY

(71) Applicant: SpotHero, Inc., Chicago, IL (US)

(72) Inventors: Tanbing Yan, Ontario (CA); Gregory Stephen Svitak, Chicago, IL (US); Ryan Carlson, Chicago, IL (US); Geoffrey A.M. Hunter, Ontario (CA); Sudhir C. Vissa, Bensenville, IL (US)

(73) Assignee: SpotHero, Inc., Chicago, IL (US)

(21) Appl. No.: 17/862,828

(22) Filed: Jul. 12, 2022

(51) Int. Cl. G06Q 30/02; G06Q 50/30

(52) U.S. Cl. CPC G06Q 30/0284; G06Q 50/30

(57) ABSTRACT

A method for operating a parking facility includes accessing a data structure comprising an array of cells defined by a plurality of columns and a plurality of rows, wherein one of the plurality of columns and the plurality of rows is time of entry and the other of the plurality of columns and the plurality of rows is duration of parking session, and each cell of the array of cells comprises a cost, and determining a parking session cost for an individual vehicle by summing costs in a plurality of cells of the array of cells corresponding to a time of entry and a parking session duration for the individual vehicle.

### TECHNICAL FIELD

The present specification generally relates to parking facilities and, more particularly, to systems and methods for operating parking facilities.

### BACKGROUND

Operators of parking facilities may manually establish parking rates based on their own historical knowledge. The rates may be applied in pricing bands that are defined by hours of the day. For example, a parking rate may be $15/hour for a first pricing band that extends from 7:00 AM to 3:00 PM and a parking rate may be $5/hour for a second pricing band that extends from 3:00 PM to 10:00 PM. However, such parking rates are coarse in that they do not reflect parking demand that may change from hour to hour and minute to minute. Such a system for setting parking rates also does not take into account how external data, such as weather data, may affect demand for parking, and how demand for parking may vary significantly within the large pricing bands.

### SUMMARY

In one embodiment, a system for operating a parking facility includes one or more processors communicatively coupled to the one or more sensors, and a non-transitory computer-readable memory storing instructions. The instructions, when executed by the one or more processors, cause the one or more processors to access a data structure including an array of cells defined by a plurality of columns and a plurality of rows, wherein one of the plurality of columns and the plurality of rows is time of entry and the other of the plurality of columns and the plurality of rows is duration of parking session, and each cell of the array of cells includes a cost. The instructions further cause the one or more processors to determine a parking session cost for an individual vehicle by summing costs in a plurality of cells of the array of cells corresponding to a time of entry and a parking session duration for the individual vehicle.

In another embodiment, a method for operating a parking facility includes accessing a data structure having an array of cells defined by a plurality of columns and a plurality of rows, wherein one of the plurality of columns and the plurality of rows is time of entry and the other of the plurality of columns and the plurality of rows is duration of parking session, and each cell of the array of cells includes a cost, and determining a parking session cost for an individual vehicle by summing costs in a plurality of cells of the array of cells corresponding to a time of entry and a parking session duration for the individual vehicle.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts an example parking facility according to one or more embodiments of the present disclosure;

FIG. 2 depicts three parking scenarios for vehicles parking in a parking facility;

FIG. 3 depicts an example data structure according to one or more embodiments described and illustrated herein;

FIG. 4 depicts another example data structure according to one or more embodiments described and illustrated herein;

FIG. 5 depicts a further portion of the data structure illustrated by FIG. 4 according to one or more embodiments described and illustrated herein;

FIG. 6 depicts a flowchart illustrating an example method of training a trained model for generating a data structure according to one or more embodiments described and illustrated herein;

FIG. 7 depicts an example tree model of a model for determining parking session cost according to one or more embodiments described and illustrated herein; and

FIG. 8 depicts an example computing system for operating a parking facility according to one or more embodiments described and illustrated herein.

### DETAILED DESCRIPTION

Referring generally to the appended figures, embodiments of the present disclosure are directed to systems and methods for operating a parking facility. Prior systems for establishing parking prices rely on pricing bands that are coarse and do not accurately capture the demand for parking at a parking facility. For example, a price band of $20/hour may be applied for a long block of time, such as 8 hours. However, $20/hour may not accurately reflect the variable demand for parking during this 8 hour block.

On the other hand, dynamic pricing based on present demand for parking is computationally expensive because it requires real-time computer modeling of parking demand. Such systems may be too expensive for parking facility operators to deploy.

Embodiments of the present disclosure provide granular pricing for parking sessions that accurately reflect demand for parking but without the high computing overhead of prior dynamic pricing systems. Particularly, embodiments of the present disclosure provide data structures for efficiently calculating accurate pricing for parking sessions that reflect parking demand. The data structures described herein comprise an array of cells defined by columns (or rows) corresponding to a time of entry and rows (or columns) corresponding to parking duration. A parking session cost for a vehicle is easily calculated by summing the cells within a region of the data structure that is defined by a parking entry time and a parking duration.

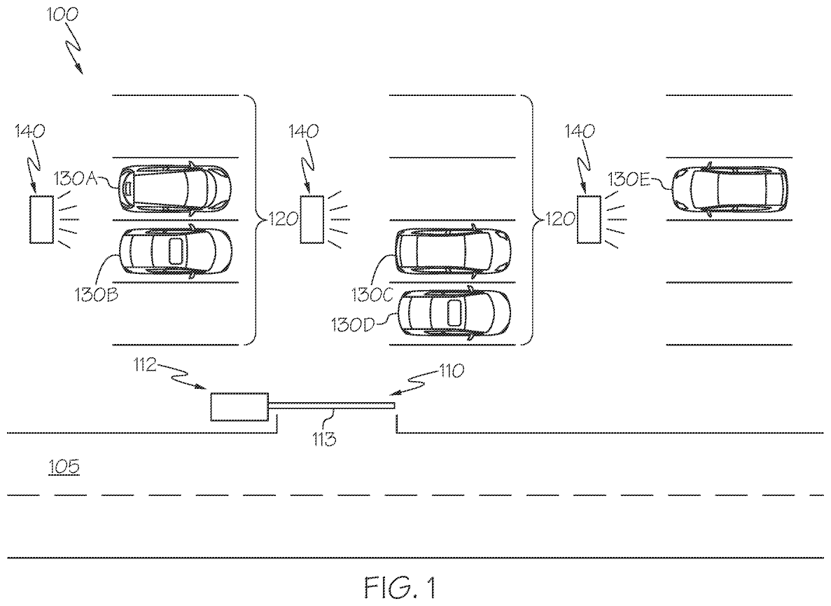

Referring now to FIG. 1, a non-limiting example parking facility 100 is illustrated. The parking facilities described herein may be any type of parking facility including, but not limited to, surface parking lots, parking garages, and on-street parking spaces (e.g., municipality operated on-street parking). The illustrated parking facility 100 is a surface parking lot having an entrance 110 off of a street 150. The entrance 110 has a gate 113 and a terminal 112, which may include payment hardware (e.g., cash acceptance hardware, credit card acceptance hardware, and/or the like) as well as a display showing current parking rates, for example.

The example parking facility 100 has a plurality of parking spaces 120 for vehicles 130 to park for a parking session. As shown in FIG. 1, vehicles 130A-130E are parked in parking spaces 120 of the parking facility 100. In some embodiments, the parking facility further includes one or more sensors 140 operable to detect whether or not a vehicle 130 is parked in a parking space. The one or more sensors 140 may include any type of sensor operable to detect a vehicle such as, without limitation, cameras, magnetic field sensors (e.g., sensors that emit a magnetic field and detect a vehicle that affects the emitted magnetic field), proximity sensors, infrared sensors, strain gauges, occupancy sensors, and/or the like. As described in more detail below, the one or more sensors 140 are used to determine an average occupancy rate for periods of time that depend on many different factors. Further, the one or more sensors 140 may provide data relating to occupancy, entry time, and exit time, both at the parking spot level (i.e., occupancy within the parking spot, entry time of the parking spot, and exit time of the parking spot) or the parking facility level (i.e., occupancy within the parking facility, entry time of the parking facility, and exit time of the parking facility). It should be understood that occupancy data may be determined by human monitoring and without the use of one or more sensors 140. The one or more sensors 140 may be used to monitor movement of vehicles within the parking facility. In some embodiments, one or more computing devices (e.g., servers) may be present at one or more parking facilities. These servers may provide data regarding vehicles entering and exiting the one or more parking facilities. This data may be used alongside the data from the one or more sensors 140, for example.

Parking facility operators may use occupancy rate to set parking costs. An occupancy rate may be the percentage of the plurality of parking spaces that are occupied by a parked vehicle (e.g., 30% occupied, 75% occupied, etc.). Using supply and demand, parking costs tend to be higher during times of a high occupancy rate when there are fewer available parking spaces in the parking facility. Many factors may affect the occupancy rate of a parking facility, such as time of year (e.g., in a very cold climate, people may stay home more often and thus not travel and park as frequently), time of day (e.g., in a business district the occupancy rate may be high during business hours whereas in an entertainment district the occupancy rate may be high during the evenings and particularly during weekend evenings), weather (e.g., people tend to not travel and park during inclement weather), and events (e.g., the occupancy rate may be high when there is a sports game or concert in the vicinity of the parking facility).

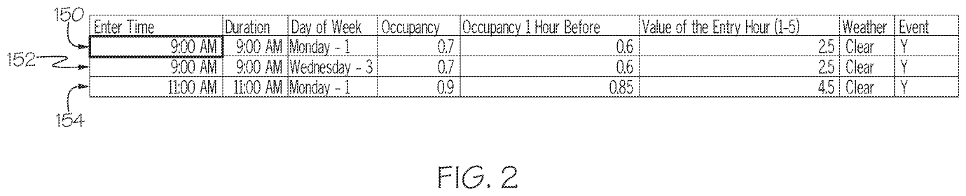

Referring now to FIG. 2, non-limiting factors for a first vehicle 150, a second vehicle 152 and a third vehicle 154 having different entry days/times at a parking facility are illustrated. For each of the three vehicles, the weather is clear and there is an event at the time of entry. The first vehicle 150 enters the parking facility at 9:00 AM on a Monday and stays for 60 minutes. The current occupancy rate of the parking facility is 70% at 9:00 AM and was 60% during the previous hour. The second vehicle 152 enters the parking facility at 9:00 AM on a Wednesday and also stays for 60 minutes. Like the first vehicle 150, the current occupancy rate of the parking facility is 70% at 9:00 AM and was 60% during the previous hour. The third vehicle 154 enters the parking facility at 11:00 AM on a Monday and also stays for 60 minutes. However, the parking facility has filled up more as compared to the 9:00 AM enter due. The occupancy rate for the third vehicle 154 arriving at 11:00 AM is 90%. It could be that more downtown workers and visitors have arrived, for example.

Based on the occupancy rate, a value may be assigned for each hour of vehicle entry. In the illustrated example, a value for the 9:00 AM enter time for the first and second vehicles 150, 152 may be 2.5 based on a 70% occupancy rate, whereas a value for the 11:00 AM enter time for the third vehicle 154 may be 4.5 based on the 90% occupancy rate. In some embodiments, a time server is used to determine entry and exit times, such as network time protocol server. The parking rate may be adjusted based on the higher value calculated for the 11:00 AM hour. This shows that entry time and duration can affect the value of a parking session. Embodiments of the present disclosure assist parking facility operators in capturing this value.

Parking facility operators typically use general knowledge to set parking rates. They do not tend to use actual historical data but rather base parking rates on a “gut feeling.” Such an approach may not fully capture the value of the parking facility. Embodiments of the present disclosure provide a data structure used for establishing parking rates based on several factors such as, without limitation, historic occupancy rate data, current occupancy rate data, weather data, and event data.

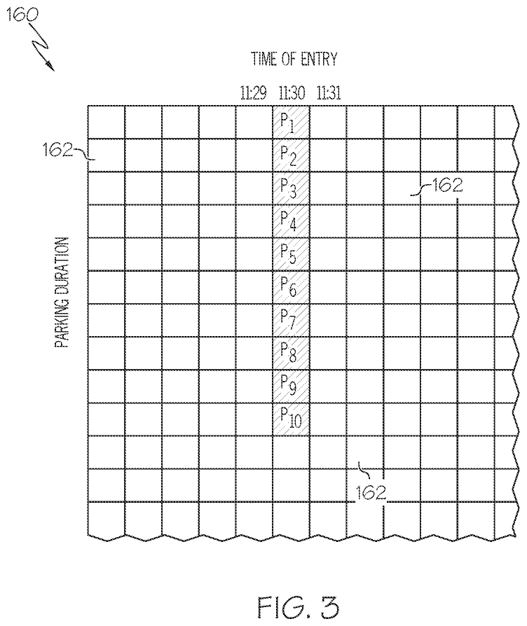

Referring now to FIG. 3, an example data structure 160 for operating a parking facility is illustrated. The example data structure 160 comprises an array of cells 162 arranged in a plurality of columns and a plurality of rows. In the illustrated embodiment, the plurality of columns is time of entry and the plurality of rows is parking duration. However, it should be understood that the plurality of columns may be parking duration and the plurality of rows may be time of entry.

Each cell in the parking duration rows is defined by a period of time. Thus, each cell represents a segment of a total parking duration having entered the parking facility at a particular time of entry. The period of time for the cells is not limited by this disclosure. For example, each cell may represent 30 seconds of parking time, 60 seconds of parking time, 5 minutes of parking, and the like.

Similarly, each cell in the time of entry columns is defined by a period of time. The period of time of the time of entry columns represents a period of time associated with entry of the vehicle into the parking facility. The period of time defined by time of entry columns may be any period of time, such as, without limitation, 30 seconds, 60 seconds, 5 minutes, and the like.

In the example of FIG. 3, a vehicle enters the parking facility at 11:30 AM and stays for 10 minutes. Each cell represents one minute of parking duration for a vehicle having entered the parking facility within a one minute entry time window. The shaded cells represent the total parking duration of the vehicle arriving at 11:30 AM. Each cell stores a cost of the segment of the parking session it represents. As described in more detail below, the costs stored within each cell may be determined by machine learning based on historic data and trends. The first minute of the parking session of the vehicle arriving at 11:30 AM is assigned cost P₁ while the final minute of the parking session of the vehicle leaving at 11:40 AM is assigned cost P₁₀. The operator of the parking facility may calculate the total cost for the parking session by simply summing the costs P₁ . . . P₁₀ of each cell of the parking duration. Previous methods of predicting parking costs are computationally expensive and time consuming because a cost for each vehicle needs to be calculated based on simulation. The data structure of the present disclosure reduces the amount of computing resources and time required to calculate a total cost of the parking session because the computer merely performs the simple operation of summing all of cells associated with the parking session. The computer modeling used to calculate the individual costs is performed on the front end and is not required to be performed for each vehicle that enters and exits the parking facility. Thus, the operation of the computer is improved.

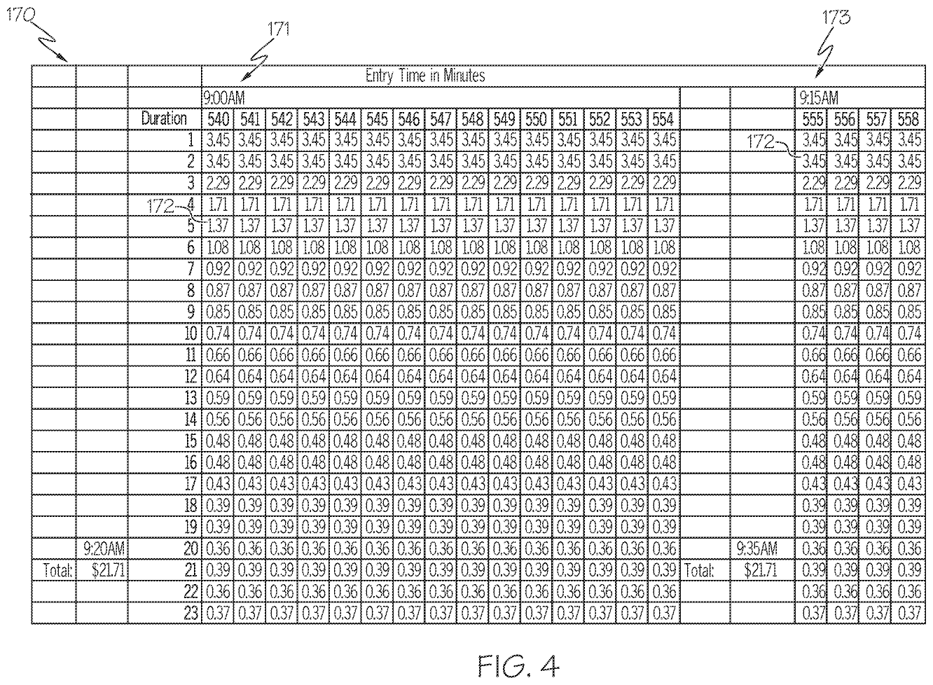

FIG. 4 illustrates a representation of a data structure 170 showing two other examples showing the difference between a vehicle arriving at 9:00 AM and a vehicle arriving at 9:15 AM. Both vehicles park for 20 minutes. Each cell 172 of the data structure 170 has a parking duration of one minute and an entry period window of one minute. The columns associated with time of entry are numbered to represent the minutes of the day (e.g., 540, 541, 542 . . . ). However, embodiments are not limited to cells having a one minute entry period.

The highlighted cells within column 171 illustrate the duration of time for the vehicle entering at 9:00 AM. The highlighted cells within column 173 illustrate the duration of time for the vehicle at 9:15 AM. Each cell stores a cost for a particular minute associated with a particular entry time. As shown in FIG. 4, a comparison between the cells of the same rows of each column reveals that in some cells the costs are the same but in other cases the costs are different. For example, the cost of the cell for the first minute of the entry time at 9:00 AM and 9:15 AM is $3.45. To calculate the total cost of a 20 minute parking session arriving at 9:00 AM, the cells of column 171 through 20 minutes of duration are summed to arrive at a parking cost of $21.71. Similarly, to calculate the total cost of a 20 minute parking session arriving at 9:15 AM, the cells of column 173 through 20 minutes of duration are summed to arrive at a parking cost of $21.71.

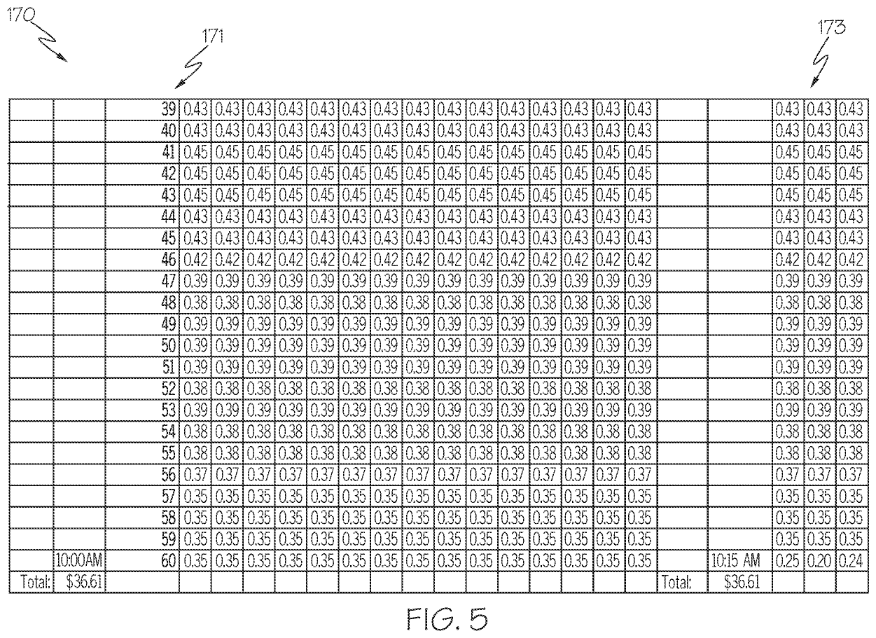

FIG. 5 illustrates a continuation of the data structure 170 example of FIG. 4 wherein the parking session duration is 60 minutes. As shown in FIG. 5, a 60 minute parking session arriving at 9:00 AM would result in a total cost of $36.61 after summing the costs of all 60 cells. A 60 minute parking session arriving at 9:15 AM would result in a total cost of $36.51 after summing the costs of all 60 cells.

After the parking session cost is calculated, it may be outputted to the owner of the vehicle by a variety of means. In one example, a payment terminal at the exit of the parking facility may display the parking session cost. In another example, an application executed on a vehicle owner's mobile electronic device may display the parking session cost. Upon payment of the parking session cost, the gate of the parking facility may open, for example.

In previous methods, the same parking rate would be charged for the vehicle arriving at 9:00 AM and for the vehicle arriving at 9:15 AM for a 60 minute parking session. However, with the embodiments of the present disclosure, additional value is generated using the data structure 170 due to a more granular and accurate pricing method.

The costs stored within the cells 162, 172 of the data structure 160, 170 are predictions of optimal costs for each parking segment (e.g., minutes) at each entry time. The costs may be calculated continuously, or in response to a trigger event, such as regular intervals, such as monthly, weekly, daily, semi-daily, hourly, events (e.g., a sporting event) for example. The costs within the cells 162, 172 of the data structure 160, 170 may be determined by a variety of ways.

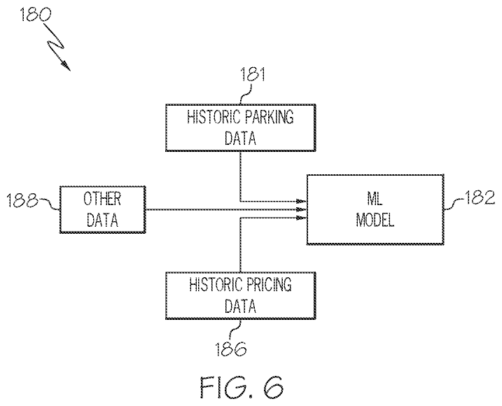

In one example, a trained model may be utilized to calculate the costs for the cells of the data structure 160, 170. Referring now to FIG. 6, a trained model 182 for calculating costs for cells of a data structure 160, 170 is illustrated. The trained model 182, which may be a neural network, for example, may be trained to receive current data (e.g., event data, weather data, date and time data, and the like), and output costs for the cells 162, 172 of the data structure 160, 170.

As shown in FIG. 6, the trained model 182 receives historic parking data 184, historic pricing data 186, and other data 188, such as event data, weather data, and any other data that may be relevant to an occupancy rate of a parking facility throughout the year. The historic parking data 184 may include occupancy rates throughout the day for every day of the year, for example. Multiple years of historic parking data 184 may be provided as training input into the trained model 182. Historic pricing data 186 includes pricing for the parking facility by time and date throughout the year. The historic pricing data 186 may be date- and time-linked to the historic parking data 184. In other embodiments, no historic pricing data 186 is used for training the trained model 182. The other data 188, which includes any other data relevant to occupancy rate, may or may not be used to train the model. As a non-limiting example, the event data may be data relating to timing of events nearby (e.g., within a predetermined radius) the parking facility, such as sports games, concerts, parades, and the like. The event data may be gathered by accessing one or more remote databases storing event data, as a non-limiting example.

The trained model 182, which may be any machine learning model, receives the inputted data and is trained to produce optimal costs of the data structure 160, 170 depending on present data. Thus, a parking facility operator may provide current data, such as current occupancy data, event data, predicted weather data, date and time data, and the like into the trained model to receive as output costs within the data structure 160, 170.

The trained model 182 may be continuously trained using the current data, such as the current occupancy rate data, weather data, event data, and the like. The trained model 182 may be maintained by the parking facility operator, or maintained by a third party that provides access to the trained model 182.

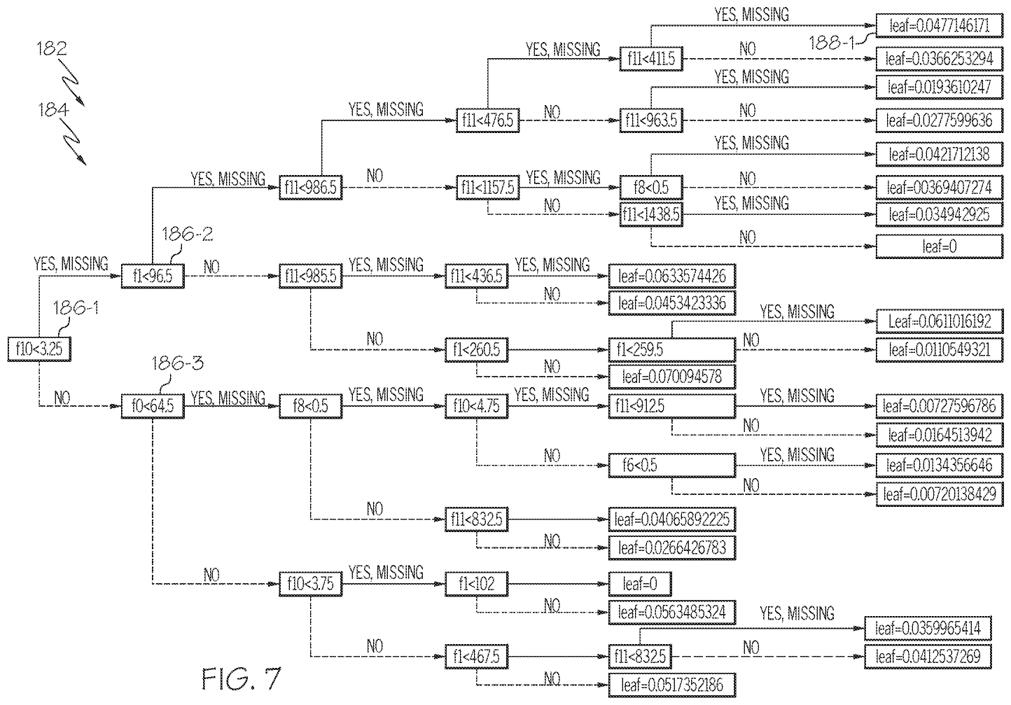

As a non-limiting example, the trained model 182 may be a gradient boosting model, such as extreme gradient boosting (XGBoost) or Light Gradient Boosting Machine (LightGBM). FIG. 7 illustrates an example individual tree model comprising a plurality of nodes 186 each including a factor and a variable. To calculate the cost for each cell, a plurality of tree models (e.g., hundreds or thousands) are generated using a selected number of factors from a plurality of factors. The leaves 188 of the tree model provide an individual model value for a particular cell. To calculate the cost for each cell (i.e., the cost for a single minute of parking per an arrival time), the output, such as the selected leave based on the input, of each tree model is summed.

Many different factors may be used for the trained model. Non-limiting example factors are provided below:
F0—‘Occupancy_lag_1’: This is an occupancy prediction one hour prior to the time of the cell being calculated
F1—‘Occupancy_lag_2’: This is an occupancy prediction two hours prior to the time of the cell being calculated
F2—‘Day_of_week_1.0’: Monday
F3—‘Day_of_week_2.0’: Tuesday
F4—‘Day_of_week_3.0’: Wednesday
F5—‘Day_of_week_4.0’: Thursday
F6—‘Day_of_week_5.0’: Friday
F7—‘Day_of_week_6.0’: Saturday
F8—‘Day_of_week_7.0’: Sunday
F9—‘Duration’: This is the duration of parking in minutes
F10—‘hourly_index’: This is an importance index based on historical transactions
F11—‘entry_minute’: This the time of entry for the cell being calculated

It should be understood that more or fewer factors may be provided, and factors F0-F11 are provided for illustrative purposes only.

The occupancy predictions for F0 and F1 may be determined by a trained model, which may output a predicted occupancy of a parking facility based on parameters. The parameters may include historical parking data, event schedules, weather data, and the like. Any model may be used to determine the occupancy predictions F0 and F1 for the cells of the data structure. As a non-limiting example, a time series model, such as Prophet offered by Facebook, may be used to predict parking facility occupancy.

F10, the houlyindex, is based on the number of vehicles coming into and out of the parking facility. The values may be assigned heuristically. For example, rush hour may be assigned a relatively high value, such as 3 or 4), and midnight may be assigned a relatively low value, such as 0.1.

As stated above, a plurality of tree models having a different combination of factors and variables are generated for each cell of the data structure. For example, one tree model may have five of the eleven factors identified above.

The example tree model 184 of FIG. 7 utilizes factors F0, F1, F6, F8, F10, and F11, with F10 being used as a first factor in the tree model 184. Values for the various factors are set for the cell under evaluation. For example, if a cell for a Monday is being calculated, F2 will be set to 0 and F3-F8 will be set to zero. Node 186-1 evaluates whether factor F10, hourly_index, is less than 3.25. If so, the process moves to node 186-2, where it is evaluated whether factor F1, occupancy_lag_2, is less than 96.5. If the answer is no at node 186-1, the process moves to node 186-3, where it is evaluated whether factor F0, occupancy_lag_1 is less than 64.5, and so on. The arrangement of the nodes, the factors evaluated by each node, and the variables used in each node may be generated automatically by the algorithm, for example.

Each branch of the tree model 184 ends in a leaf, such as leaves 188-1 and 188-2. Each leaf includes an individual model value that is used to calculate the overall cost for an individual cell. The tree model 184 is trained to calculate individual model values that will yield an optical cost based on historical pricing data. For example, an objective function may be used to determine the individual model values that minimize a discrepancy between a calculated cost and an optimal cost.

As stated above, many individual tree models (e.g., hundreds or thousands) are executed for each cell. The individual model values of the many individual tree models are summed and the result is stored in the appropriate cell of the data structure.

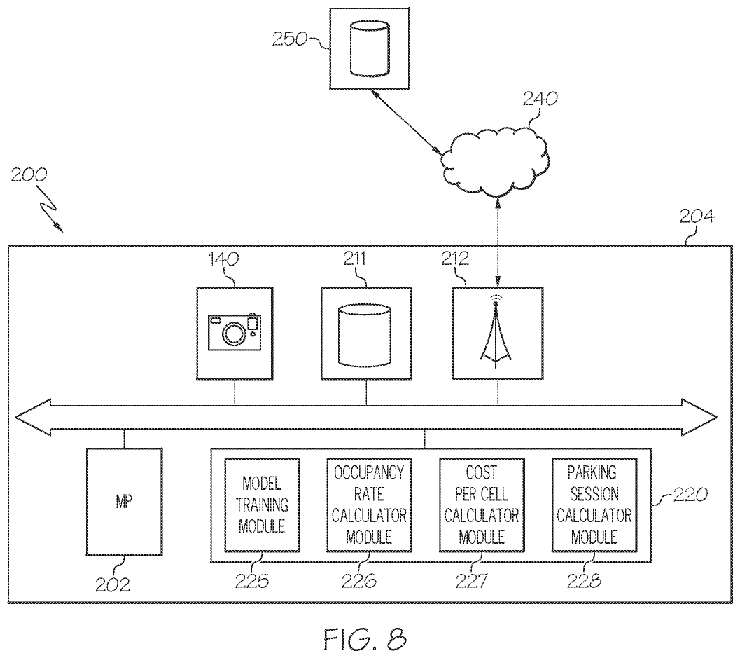

FIG. 8 depicts an example system 200 for performing the functionalities as described herein. The system 200 may be maintained by a parking facility operator or a third party service provider. The example computing system 200 includes one or more processors 202, a communication path 204, one or more memory modules 220, one or more sensors 140, network interface hardware 212, and a data storage device 211, the details of which will be set forth in the following paragraphs. It should be understood that the computing system 200 of FIG. 8 is provided for illustrative purposes only, and that other computing systems comprising more, fewer, or different components may be utilized.

The one or more sensors 140 may include one or more cameras that are operable to detect vehicles parked in parking spots of the parking facility. The one or more sensors 140 may also include magnetic field sensors operable to detect the presence of the vehicle. It should be understood that other types of sensors capable of detecting vehicles may be utilized. The one or more sensors 140 may be communicatively coupled to the communication path by either a wired or wireless connection.

Each of the one or more processors 202 may be any device capable of executing computer readable and executable instructions. Accordingly, each of the one or more processors 202 may be a controller, an integrated circuit, a microchip, a computer, or any other computing device. The one or more processors 202 are coupled to a communication path 204 that provides signal interconnectivity between various modules of the computing system 200. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as WiFi, Bluetooth®, Near Field Communication (NFC) and the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The computing system 200 includes one or more memory modules 220 coupled to the communication path 204. The one or more memory modules 220 may comprise RAM, ROM, flash memories, hard drives, or any device capable of storing computer readable and executable instructions such that the computer readable and executable instructions can be accessed by the one or more processors 202. The computer readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into computer readable and executable instructions and stored on the one or more memory modules 220. Alternatively, the computer readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

The one or more memory modules 206 may be configured as volatile and/or nonvolatile memory and, as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. The one or more memory modules 220 include logic in the form of computer readable instructions that perform the functionalities described herein, such as a model training module 225, an occupancy rate calculator module 226, a cost per cell calculation module 227, and a parking session calculation module 228. Additional logic used to support these functionalities may be stored in the one or more memory modules 220 and/or in remote memory modules.

The model training module 225 may include logic capable of training the trained module 182, which may be stored in the data storage device 211 or on a remote server. The model training module 225 may receive the training data (e.g., historic parking data 184, historic pricing data, 186 and other data 188) and train the trained model 182 to produce optimal costs for each cell of the data structure when the trained model 182 receives input data (e.g., weather forecast data, event data, present occupancy rate data).

The occupancy rate calculator module 226 includes logic capable of calculating the occupancy rate of the parking facility over time. This occupancy rate may be used as the historic parking data 184 that is used to train the trained model, for example. The occupancy rate calculator module 226 may receive data from the one or more sensors 140 to determine a total number of vehicles parked within the parking facility, and then calculate the occupancy rate by dividing the number of vehicles detected by the total number of parking spaces within the parking facility. The occupancy rate may be stored as historic parking data that is stored in the data storage device 211 or some other remote server.

The cost per cell calculation module 227 includes logic that accesses the trained model 182 that is trained by the model training module 225 and calculates the optimal cost for each cell of the data structure 160, 170. The cost per cell calculation module 227 may receive current data, such as weather forecast data, event data, and current occupancy rate data, and input the current data into the trained model 182 to calculate the cost per cell of the data structure 160, 170.

The parking session calculation module 228 includes logic that calculates the cost for individual parking sessions. The parking session calculation module 228 may receive an entry time of a vehicle (e.g., the date and time that a vehicle owner takes a ticket, scans into the parking facility, or otherwise enters the parking facility) and an exit time of the vehicle (e.g., the data and time that the vehicle owner submits his or her ticket, scans to exit the parking facility, or otherwise exits the parking facility). A parking session duration may be calculated based on the entry time and the exit time. To calculate the cost of the parking session, the parking session calculation module 228 may access the data structure 160, 170 and locate the column (or row) having the same time as the entry time of the vehicle, sum the costs within the cells in the rows (or columns) that overlap with the parking session duration.

The data storage device 211, which may generally be a storage medium, may contain one or more data repositories for storing data that is received and/or generated, and may be any physical storage medium, including, but not limited to, a hard disk drive (HDD), memory, removable storage, and/or the like. While the data storage device 211 is depicted as a local device, it should be understood that the data storage device 211 may be a remote storage device, such as, for example, a server computing device or the like. In some embodiments, the data storage device 211 stores information for performing the functionalities described herein. It should be understood that the data storage device is not provided in some embodiments.

Still referring to FIG. 8, the computing system 200 may comprise network interface hardware 212 for communicatively coupling the computing system 200 to a remote computing device. The network interface hardware 212 can be communicatively coupled to the communication path 204 and can be any device capable of transmitting and/or receiving data via a network 440. Accordingly, the network interface hardware 212 can include a communication transceiver for sending and/or receiving wireless communications. For example, the network interface hardware 212 may include an antenna, a modem. LAN port, Wi-Fi card, WiMax card, mobile communications hardware, near-field communication hardware, satellite communication hardware and/or any wired or wireless hardware for communicating with other networks and/or devices. In one embodiment, the network interface hardware 212 includes hardware configured to operate in accordance with the Bluetooth® wireless communication protocol. In some embodiments, the network interface hardware 212 is configured to communicate with remote computing devices by V2I and/or vehicle-to-vehicle (V2V) communication protocols.

The network interface hardware 212 may be used to communicate with external databases and/or remote servers. FIG. 8 illustrates an example external database 250 that is communicatively coupled to the network interface hardware 212 by a communications network 240, such as the Internet. The external database 250 may hold data used by the various modules, such as weather databases, event databases, and databases holding any other data that may be used to generate a data structure for determining parking session costs as described herein.

It should now be understood that embodiments of the present disclosure are directed to systems and methods for operating a parking facility. Embodiments improve over prior systems by providing more granular pricing that accurately reflects parking conditions. Embodiments further improve over prior systems by reducing computer processing power because the prediction of parking costs need only be calculated once per day (or more depending on the embodiment) and that prediction may be applied to all vehicles entering the parking facility as opposed to continuously predicting parking session costs for individual vehicles. In embodiments, a data structure is generated that includes cells defined by parking duration segments (e.g., a minute in length) and parking entry time (e.g., parking entry minute). A parking session cost is calculated by summing the cells within a region of the data structure that is defined by a parking entry time and a parking duration.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A system for operating a parking facility, the system comprising:
one or more processors communicatively coupled to the one or more sensors; and
a non-transitory computer-readable memory storing instructions that, when executed by the one or more processors, cause the one or more processors to:
access a data structure comprising an array of cells defined by a plurality of columns and a plurality of rows, wherein one of the plurality of columns and the plurality of rows is time of entry and the other of the plurality of columns and the plurality of rows is duration of parking session, and each cell of the array of cells comprises a cost; and
determine a parking session cost for an individual vehicle by summing costs in a plurality of cells of the array of cells corresponding to a time of entry and a parking session duration for the individual vehicle.

2. The system of claim 1, wherein each cell represents one minute of parking duration at an individual minute of entry time.

3. The system of claim 1, wherein the cost stored within each cell of the array of cells is determined based on a plurality of factors.

4. The system of claim 3, wherein the data is received from one or more sensors that are configured to monitor one or more parking spaces.

5. The system of claim 4, wherein the one or more sensors are configured to monitor one or more of an occupancy, an entry time, and an exit time at a parking spot level or a parking facility level.

6. The system of claim 1, wherein the cost stored within each cell of the array of cells is determined by a trained model.

7. The system of claim 6, wherein the trained model receives as input weather data and date and time data.

8. The system of claim 7, wherein the trained model further receives as input event data.

9. The system of claim 1, wherein the cost for each cell is calculated on a continuous basis.

10. The system of claim 1, wherein the cost for each cell is calculated in response to a trigger event.

11. A method for operating a parking facility, the method comprising:
accessing a data structure comprising an array of cells defined by a plurality of columns and a plurality of rows, wherein one of the plurality of columns and the plurality of rows is time of entry and the other of the plurality of columns and the plurality of rows is duration of parking session, and each cell of the array of cells comprises a cost; and
determining a parking session cost for an individual vehicle by summing costs in a plurality of cells of the array of cells corresponding to a time of entry and a parking session duration for the individual vehicle.

12. The system of claim 11, wherein each cell represents one minute of parking duration at an individual minute of entry time.

13. The method of claim 11, wherein the cost stored within each cell of the array of cells is determined based on data received from one or more sensors relating to the vehicles parked within the parking facility.

14. The method of claim 13, wherein the data is received from one or more sensors that are configured to monitor one or more parking spaces and vehicles moving within the parking facility.

15. The method of claim 14, wherein the one or more sensors are configured to monitor one or more of an occupancy, an entry time, and an exit time at a parking spot level or a parking facility level.

16. The method of claim 11, wherein the cost stored within each cell of the array of cells is determined by a trained model.

17. The method of claim 16, wherein the trained model receives as input weather data and date and time data.

18. The method of claim 17, wherein the trained model further receives as input event data.

19. The method of claim 11, wherein the cost for each cell is calculated on a continuous basis.

20. The method of claim 11, wherein the cost for each cell is calculated in response to a trigger event.
